(19) United States
(12) Patent Application Publication
(10) Pub. No.: US 2018/0187326 A1
(43) Pub. Date: Jul. 5, 2018

(54) SENSOR GROWTH CONTROLLER

(71) Applicant: General Atomics, San Diego, CA (US)

(72) Inventor: Wen Chan, Cedar Valley (CA)

(21) Appl. No.: 15/782,330

(22) Filed: Oct. 12, 2017

Related U.S. Application Data
(63) Continuation of application No. 14/454,665, filed on Aug. 7, 2014, now abandoned.
(60) Provisional application No. 61/863,380, filed on Aug. 7, 2013.

(51) Int. Cl. C25D 21/12; C25D 17/12; G01N 27/327; C25D 5/18

(52) U.S. Cl. CPC C25D 21/12; C25D 17/12; C25D 17/005; C25D 5/18; G01N 27/3278; G01N 27/327

(57) ABSTRACT

A method for plating electrodes includes contacting a substrate with an electrolyte, the substrate comprising a plurality of working electrodes, applying an electric potential to one or more working electrodes of the plurality of working electrodes, monitoring a separate current through each of the one or more working electrodes of the plurality of working electrodes, and in response to determining that a first current through a first electrode of the plurality of working electrodes has reached a predetermined value, interrupting the first current through the first working electrode.

### CROSS-REFERENCE TO RELATED APPLICATIONS

This application claims the benefit of U.S. Provisional Application No. 61/863,380, filed on Aug. 7, 2013, which is hereby incorporated herein by reference in its entirety.

### BACKGROUND

The development of low cost, high throughput sensors that can detect biomolecular targets with high sensitivity is highly desirable. For such purposes, producing sensing electrodes capable of reproducibly achieving such sensitivity is non-trivial. Thus, alternative systems and methods for fabricating such sensors could be beneficial to multiplexed detection applications.

### SUMMARY

Disclosed herein are systems, devices, and methods for controlling the growth of nanostructured microelectrodes for use as sensors in the detection of biomolecules. In electroplating nanostructured microelectrodes, traditional electroplating methods can produce uneven sizes and inconsistent morphologies. Such uneven growth is caused by the tendency for the largest surface area electrode to have the greatest growth rate due to its larger demand for current. In some implementations, a plate stop controller helps regulate the final electrode surface area by individually monitoring the electrode currents and interrupting the current flow to individual electrodes as they reach a target current that is indicative of the surface area of the electrode.

In one aspect, a method for plating electrodes includes contacting a substrate with an electrolyte, the substrate having a plurality of working electrodes, applying an electric potential to each of the plurality of working electrodes, monitoring a separate current through each of the plurality of working electrodes, interrupting the first current through the first working electrode in response to determining that a first current through a first electrode of the plurality of working electrodes has reached a predetermined value. In certain implementations, applying the potential to the first electrode produces a nanostructured microelectrode. In some implementations, interrupting the first current includes removing the potential applied to the first working electrode while continuously applying the potential to the remaining working electrodes of the plurality of electrode leads. The plurality of working electrodes may share a common counter electrode and the common counter electrode may be shaped such that a resistance between each of the plurality of working electrodes and the common counter electrode is substantially similar among the plurality of working electrodes.

In certain implementations, the potential applied to each of the plurality of working electrodes is controlled by a common potentiostat. The currents measured through each of the plurality of working electrodes may be indicative of a surface area of their respective working electrodes. In certain implementations, the method further includes determining that a second current through a second electrode of the plurality of electrode leads has reached a predetermined value, and in response to determining that the second current has reached the predetermined value, removing the potential applied to the second electrode lead. In such implementations, the surface area of the first electrode is substantially similar to the surface area of the second electrode after the potential applied to the second electrode is removed.

In some implementations, a method for controlling an electrode morphology comprises applying a first waveform of alternating polarity to a working electrode. If it is determined that a current through the working electrode has reached a predetermined range, the first waveform is removed and a second waveform of a non-alternating polarity is applied to the working electrode. This helps to produce a dense seed layer on the working electrode, and facilitate the formation of fine structure in the resultant nanostructured microelectrode. The predetermined range may be indicative of a size of the working electrode. In certain implementations, a first polarity of the waveform has a longer duration than a duration of a second polarity. The second waveform may comprise an exponential decay having a plurality of peaks distributed along an exponential decay. In some implementations, a system for plating electrodes includes control circuitry configured to perform any of the methods described above or any combination thereof.

In another aspect, a system for plating electrodes includes a solid support with a plurality of working electrodes distributed on its surface, and a counter electrode that has conductive and insulating regions. The conductive region is spaced a distance away from the plurality of working electrodes, and the insulator covers a portion of the conductive region such that current flow from a particular working electrode to the portion of the counter electrode is effectively blocked. This provides a substantially uniform effective resistance between each of the plurality of working electrodes and the counter electrode to reduce unevenness in the size (e.g., average diameter) of the working electrodes. The counter electrode may be shaped, for example it may include curved or linear sections. The counter electrode may be configured to fit within a Petri dish. In certain implementations, each of the plurality of working electrodes is operably coupled to a common potential. The insulator may cover a portion or portions of the counter electrode. In some implementations, the counter electrode further includes a planar portion that is substantially parallel to the solid support and an angled portion that extends at an angle from the planar portion. The counter electrode may be formed into the shape of an electrolyte confinement well. In some implementations, a point-of-care diagnostic device includes a biosensor having electrodes produced according to any of the preceding methods or any combination thereof.

### BRIEF DESCRIPTION OF THE DRAWINGS

The foregoing and other objects and advantages will be apparent upon consideration of the following detailed description, taken in conjunction with the accompanying drawings, in which like reference characters refer to like parts throughout, and in which:

FIG. 1 depicts a schematic of the electrochemical detection of a target;

FIG. 2 depicts an illustrative electrochemical readout indicating the presence/absence of a target;

FIG. 3 depicts an illustrative nanostructured microelectrode-based electrochemical detector;

FIG. 4 depicts a schematic of an illustrative plate stop controller.

FIG. 5 depicts an illustrative waveform for growing a seed layer on a working electrode.

FIG. 6 depicts an illustrative waveform for growing a nanostructured microelectrode.

FIG. 7 depicts illustrative configurations for counter electrodes.

FIG. 8 depicts an illustrative cartridge system for receiving, preparing, and analyzing a biological sample;

FIG. 9 depicts an illustrative cartridge for an analytical detection system;

FIG. 10 depicts an illustrative automated testing system;

FIG. 11 depicts an NME plating system having a linear counter electrode;

FIG. 12 depicts a plating system having a shaped counter electrode;

FIG. 13 depicts NMEs created using the plating system of FIG. 11; and

FIG. 14 depicts NMEs created using the plating system of FIG. 12.

### DETAILED DESCRIPTION

To provide an overall understanding of the systems, devices, and methods described herein, certain illustrative implementations will be described. It is to be understood that the systems, devices, and methods disclosed herein, while shown for use in diagnostic systems for the detection of biological disease markers, may be applied to other systems that require multiplexed electrochemical analysis.

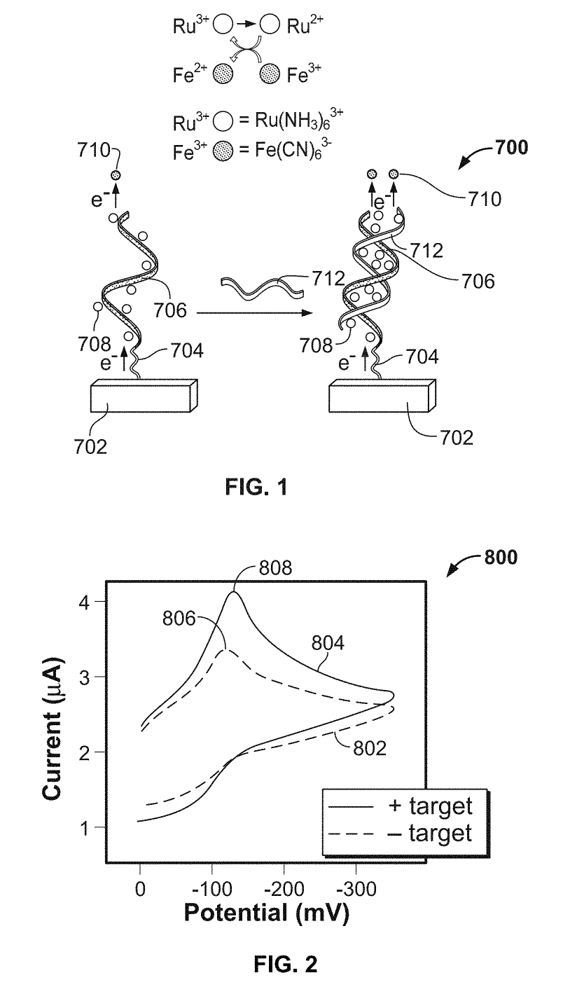

FIGS. 1-4 depict illustrative tools, sensors, biosensors, and techniques for detecting target analytes, including cellular, molecular, or tissue components, by electrochemical methods. FIG. 1 depicts electrochemical detection of a nucleotide strand using a biosensor system. System 700 includes an electrode 702 with an associated probe 706 attached to the electrode 702 via a linker 704. Electrode 702 can be any of the working electrodes of chip 100. The probe 706 is a molecule or group of molecules, such as nucleic acids (e.g., DNA, RNA, cDNA, mRNA, rRNA, etc.), oligonucleotides, peptide nucleic acids (PNA), locked nucleic acids, proteins (e.g., antibodies, enzymes, etc.), or peptides, that is able to bind to or otherwise interact with a biomarker target (e.g., receptor, ligand) to provide an indication of the presence of the ligand or receptor in a sample. The linker 704 is a molecule or group of molecules which tethers the probe 706 to the electrode 702, for example, through a chemical bond, such as a thiol bond.

In some implementations, the probe 706 is a polynucleotide capable of binding to a target nucleic acid sequence through one or more types of chemical bonds, such as complementary base pairing and hydrogen bond formation. This binding is also called hybridization or annealing. For example, the probe 706 may include naturally occurring nucleotide and nucleoside bases, such as adenine (A), guanine (G), cytosine (C), thymine (T), and uracil (U), or modified bases, such as 7-deazaguanosine and inosine. The bases in probe 706 can be joined by a phosphodiester bond (e.g., DNA and RNA molecules), or with other types of bonds. For example, the probe 706 can be a peptide nucleic acid (PNA) oligomer in which the constituent bases are joined by peptide bonds rather than phosphodiester linkages. A peptide nucleic acid (PNA) oligomer may contain a backbone comprised of N-(2-aminoethyl)-glycine units linked by peptide bonds. Peptide nucleic acids have a higher binding affinity and increased specificity to complementary nucleic acid oligomers, and accordingly, may be particularly beneficial in diagnostic and other sensing applications, as described herein.

In some implementations, the probe 706 has a sequence partially or completely complementary to a target marker 712, such as a nucleic acid sequence sought. Target marker 712 is a molecule for detection, as will be described in further detail below. In some implementations, probe 706 is a single-stranded oligonucleotide capable of binding to at least a portion of a target nucleic acid sought to be detected.

In certain approaches, the probe 706 has regions which are not complementary to a target sequence, for example, to adjust hybridization between strands or to serve as a non-sense or negative control during an assay. The probe 706 may also contain other features, such as longitudinal spacers, double-stranded regions, single-stranded regions, poly(T) linkers, and double stranded duplexes as rigid linkers and PEG spacers. In certain approaches, electrode 702 can be configured with multiple, different probes 706 for multiple, different targets 712.

The probe 706 includes a linker 704 that facilitates binding of the probe 706 to the electrode 702. In certain approaches, the linker 704 is associated with the probe 706 and binds to the electrode 702. For example, the linker 704 may be a functional group, such as a thiol, dithiol, amine, carboxylic acid, or amino group. For example, it may be 4-mercaptobenzoic acid coupled to a 5′ end of a polynucleotide probe. In certain approaches, the linker 704 is associated with the electrode 702 and binds to the probe 706. For example, the electrode 702 may include an amine, silane, or siloxane functional group. In certain approaches, the linker 704 is independent of the electrode 702 and the probe 706. For example, linker 704 may be a molecule in solution that binds to both the electrode 702 and the probe 706.

Under appropriate conditions, such as in a suitable hybridization buffer, the probe 706 can hybridize to a complementary target marker 712 to provide an indication of the presence of target marker 712 in a sample. In certain approaches, the sample is a biological sample from a biological host. For example, a sample may be tissue, cells, proteins, fluid, genetic material, bacterial matter or viral matter, plant matter, animal matter, cultured cells, or other organisms or hosts. The sample may be a whole organism or a subset of its tissues, cells or component parts, and may include cellular or noncellular biological material. Fluids and tissues may include, but are not limited to, blood, plasma, serum, cerebrospinal fluid, lymph, tears, saliva, blood, mucus, lymphatic fluid, synovial fluid, cerebrospinal fluid, amniotic fluid, amniotic cord blood, urine, vaginal fluid, semen, tears, milk, and tissue sections. The sample may contain nucleic acids, such as deoxyribonucleic acids (DNA), ribonucleic acids (RNA), or copolymers of deoxyribonucleic acids and ribonucleic acids or combinations thereof. In certain approaches, the target marker 712 is a nucleic acid sequence that is known to be unique to the host, pathogen, disease, or trait, and the probe 704 provides a complementary sequence to the sequence of the target marker 712 to allow for detection of the host sequence in the sample.

In certain aspects, systems, devices and methods are provided to perform processing steps, such as purification and extraction, on the sample. Analytes or target molecules for detection, such as nucleic acids, may be sequestered inside of cells, bacteria, or viruses. The sample may be processed to separate, isolate, or otherwise make accessible, various components, tissues, cells, fractions, and molecules included in the sample. Processing steps may include, but are not limited to, purification, homogenization, lysing, and extraction steps. The processing steps may separate, isolate, or otherwise make accessible a target marker, such as the target marker 712 in or from the sample.

In certain approaches, the target marker 712 is genetic material in the form of DNA or RNA obtained from any naturally occurring prokaryotes such, pathogenic or non-pathogenic bacteria (e.g., Escherichia, Salmonella, Clostridium, Chlamydia, etc.), eukaryotes (e.g., protozoans, parasites, fungi, and yeast), viruses (e.g., Herpes viruses, HIV, influenza virus, Epstein-Barr virus, hepatitis B virus, etc.), plants, insects, and animals, including humans and cells in tissue culture. Target nucleic acids from these sources may, for example, be found in biological samples of a bodily fluid from an animal, including a human. In certain approaches, the sample is obtained from a biological host, such as a human patient, and includes non-human material or organisms, such as bacteria, viruses, other pathogens.

A target nucleic acid molecule, such as target marker 712, may optionally be amplified prior to detection. The target nucleic acid can be in a double-stranded or single-stranded form. A double-stranded form may be treated with a denaturation agent to render the two strands into a single-stranded form, or partially single-stranded form, at the start of the amplification reaction, by methods such as heating, alkali treatment, or by enzymatic treatment.

Once the sample has been treated to expose a target nucleic acid, e.g., target molecule 712, the sample solution can be tested as described herein to detect hybridization between probe 706 and target molecule 712. For example, electrochemical detection may be applied as will be described in greater detail below. If target molecule 712 is not present in the sample, the systems, device, and methods described herein may detect the absence of the target molecule. For example, in the case of diagnosing a bacterial pathogen, such as Chlamydia trachomatis (CT), the presence in the sample of a target molecule, such as an RNA sequence from Chlamydia trachomatis, would indicate presence of the bacteria in the biological host (e.g., a human patient), and the absence of the target molecule in the sample indicates that the host is not infected with Chlamydia trachomatis. Similarly, other markers may be used for other pathogens and diseases.

Referring to FIG. 1, the probe 706 of the system 700 hybridizes to a complementary target molecule 712. In certain approaches, the hybridization is through complementary base pairing. In certain approaches, mismatches or imperfect hybridization may also take place. “Mismatch” typically refers to pairing of noncomplementary nucleotide bases between two different nucleic acid strands (e.g., probe and target) during hybridization. Complementary pairing is commonly accepted to be A-T, A-U, and C-G. Conditions of the local environment, such as ionic strength, temperature, and pH can effect the extent to which mismatches between bases may occur, which may also be termed the “specificity” or the “stringency” of the hybridization. Other factors, such as the length of a nucleotide sequence and type of probe, can also affect the specificity of hybridization. For example, longer nucleic acid probes have a higher tolerance for mismatches than shorter nucleic acid probes. In general, protein nucleic acid probes provide higher specificity than corresponding DNA or RNA probes.

As illustrated in the figures, the presence or absence of target marker 712 in the sample is determined through electrochemical techniques. These electrochemical techniques allow for the detection of extremely low levels of nucleic acid molecules, such as a target RNA molecule obtained from a biological host. Applications of electrochemical techniques are described in further detail in U.S. Pat. Nos. 7,361,470 and 7,741,033, and PCT Application No. PCT/US12/024015, which are hereby incorporated by reference herein in their entireties. A brief description of these techniques, as applied to the current system, is provided below, it being understood that the electrochemical techniques are illustrative and non-limiting and that other techniques can be envisaged for use with the other systems, devices and methods of the current system.

In the electrochemical application of FIG. 1, a solution sample is applied to the working electrode 702. In practice, a redox pair having a first transition metal complex 708 and a second transition metal complex 710 is added to the sample solution. A signal generator or potentiostat is used to apply an electrical signal to the working electrode 702, causing the first transition metal complex 708 to change oxidative states, due to its close association with the working electrode 702 and the probe 706. Electrons can then be transferred to the second transition metal complex 710, creating a current through the working electrode 702, through the sample, and back to the signal generator. The current signal is amplified by the presence of the first transition metal complex 708 and the second transition metal complex 710, as will be described below.

The first transition metal complex 708 and the second transition metal complex 710 together form an electrochemical reporter system which amplifies the signal. A transition metal complex is a structure composed of a central transition metal atom or ion, generally a cation, surrounded by a number of negatively charged or neutral ligands possessing lone pairs of electrons that can be transferred to the central transition metal. A transition metal complex (e.g., complexes 708 and 710) includes a transition metal element found between the Group IIA elements and the Group JIB elements in the periodic table. In certain approaches, the transition metal is an element from the fourth, fifth, or sixth periods between the Group IIA elements and the Group JIB elements of the periodic table of elements. In some implementations, the first transition metal complex 708 and second transition metal complex 710 include a transition metal selected from the group comprising cobalt, iron, molybdenum, osmium, ruthenium and rhenium. In some implementations, the ligands of the first transition metal complex 708 and second transition metal complex 710 is selected from the group comprising pyridine-based ligands, phenathroline-based ligands, heterocyclic ligands, aquo ligands, aromatic ligands, chloride (CF), ammonia (NH₃⁺), or cyanide (CN⁻). In certain approaches, the first transition metal complex 108 is a transition metal ammonium complex. For example, as shown in FIG.

1, the first transition metal complex 108 is Ru(NH₃)₆³⁺. In certain approaches, the second transition metal complex 710 is a transition metal cyanate complex. For example, as shown in FIG. 1, the second transition metal complex is Fe(CN)₆³⁻. In certain approaches, the second transition metal complex 710 is an iridium chloride complex such as IrCl₆²⁻ or IrCl₆³⁻.

In certain applications, if the target molecule 712 is present in the sample solution, the target molecule 712 will hybridize with the probe 706, as shown on the right side of FIG. 1. The first transition metal complex 108 (e.g., Ru(NH₃)₆³⁺) is cationic and accumulates, due to electrostatic attraction forces as the nucleic acid target molecule 712 hybridizes at the probe 706. The second transition metal complex 710 (e.g., Fe(CN)₆³⁻) is anionic and is repelled from the hybridized target molecule 712 and probe 706. A signal generator, such as a potentiostat, is used to apply a voltage signal to the electrode. As the signal is applied, the first transition metal complex 708 is reduced (e.g., from Ru(NH₃)₆³⁺ to Ru(NH₃)₆²⁺). The reduction of the second metal complex 710 (e.g., Fe(CN)₆³⁻) is more thermodynamically favorable, and accordingly, electrons (e) are shuttled from the reduced form of the first transition metal complex 708 to the second transition metal complex 710 to reduce the second transition metal complex (e.g., Fe(CN)₆³⁻ to Fe(CN)₆⁴⁻ ) and regenerate the original first transition metal complex 708 (e.g., Ru(NH₃)₆³⁺). This catalytic shuttling process allows increased electron flow through the working electrode 702 when the potential is applied, and amplifies the response signal (e.g., a current), when the target molecule 712 is present. When the target molecule 712 is absent from the sample, the measured signal is significantly reduced.

Chart 800 of FIG. 2 depicts representative electrochemical detection signals. A signal generator such as a potentiostat, is used to apply a voltage signal at an electrode, such as working electrode 702 of FIG. 1. Electrochemical techniques including, but not limited to cyclic voltammetry, amperometry, chronoamperometry, differential pulse voltammetry, calorimetry, and potentiometry may be used for detecting a target marker. In certain approaches, an applied potential or voltage is altered over time. For example, the potential may be cycled or ramped between two voltage points, such from 0 mV to −300 mV and back to 0 mV, while measuring the resultant current. Accordingly, chart 800 depicts the current along the vertical axis at corresponding potentials between 0 mV and −300 mV, along the horizontal axis. Data graph 802 represents a signal measured at an electrode, such as working electrode 702 of FIG. 1, in the absence of a target marker. Data graph 704 represents a signal measured at an electrode, such as working electrode 702 of FIG. 1, in the presence of a target marker. As can be seen on data graph 804, the signal recorded in the presence of the target molecule provides a higher amplitude current signal, particularly when comparing peak 808 with peak 806 located at approximately −100 mV. Accordingly, the presence and absence of the marker can be differentiated.

In certain applications, a single electrode or sensor is configured with two or more probes, arranged next to each other, or on top of or in close proximity within the chamber so as to provide target and control marker detection in an even smaller point-of-care size configuration. For example, a single electrode sensor may be coupled to two types of probes, which are configured to hybridize with two different markers. In certain approaches, a single probe is configured to hybridize and detect two markers. In certain approaches, two types of probes may be coupled to an electrode in different ratios. For example, a first probe may be present on the electrode sensor at a ratio of 2:1 to the second probe. Accordingly, the sensor is capable of providing discrete detection of multiple analytes. For example, if the first marker is present, a first discrete signal (e.g., current) magnitude would be generated, if the second marker is present, a second discrete signal magnitude would be generated, if both the first and second marker are present, a third discrete signal magnitude would be generated, and if neither marker is present, a fourth discrete signal magnitude would be generated. Similarly, additional probes could also be implemented for increased numbers of multi-target detection.

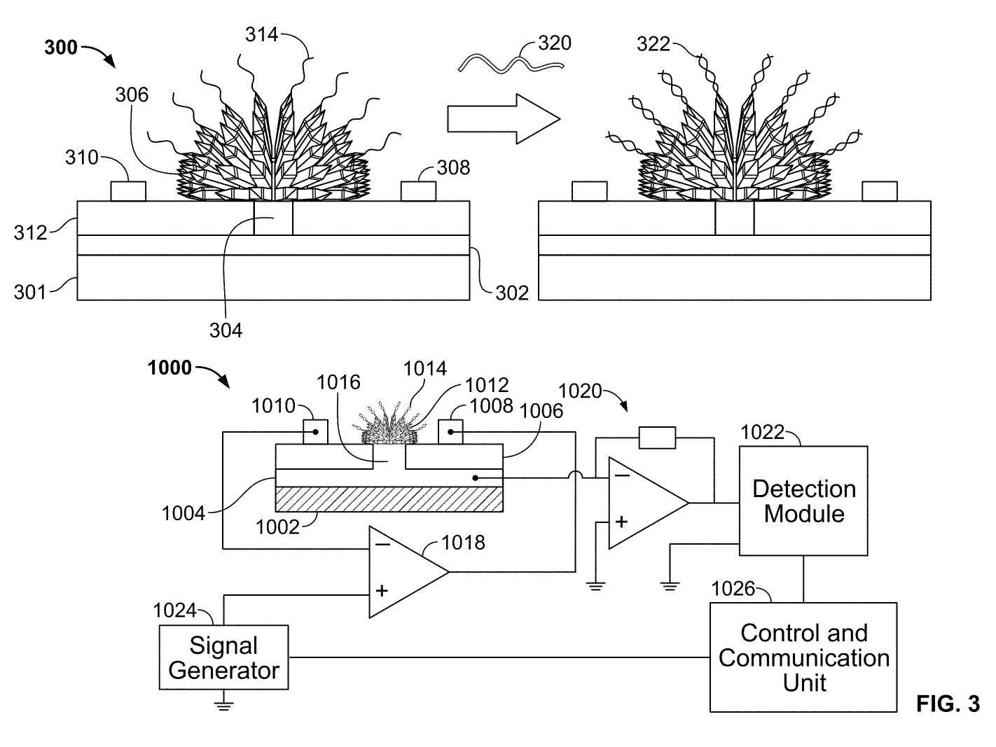

FIG. 3 depicts a detection system using a nanostructured microelectrode for electrochemical detection of a nucleotide strand, in accordance with an implementation. Nanostructured microelectrodes are microscale electrodes with nanoscale features. Nanostructured microelectrode systems are described in further detail in U.S. application Ser. No. 13/061,465, U.S. Pat. Nos. 7,361,470 and 7,741,033, and PCT Application No. PCT/US12/024015, which are hereby incorporated by reference herein in their entireties. Functionalized detection unit 300 utilizes a nanostructured microelectrode as a working electrode, which increases the sensitivity of the system by dramatically increasing the surface-area of the working electrode.

Probe 314 is tethered to working electrode 306 along with other probes that are chemically identical to probe 314, using any suitable method described herein. Probe 314 is specific to target marker 320, and may be any suitable type of probe, such as a PNA probe. Probe 314 may be tethered to working electrode 306 using any suitable method. For example, thiol-modified oligonucleotides may be used to bond probe 314 to a working electrode 306 having a gold surface. Upon introduction of target marker 320 into the sample well, complex 322 may be formed by selective binding of target marker 320 with probe 314. Electrochemical reagents may be pre-mixed with the sample upon application to the sample well. In some implementations, the sample is flushed from the sample wells after a time interval has passed to allow binding of target marker 320 with probe 314, and a solution containing electrochemical reagents is then added to the sample well to enable electrochemical detection.

FIG. 3 also shows an exemplary system for detecting a target marker in accordance with the various implementations described herein. The detection system 1000 includes solid support or substrate 1002, lead 1004, aperture layer 1006, counter electrode 1008, reference electrode 1010, and working electrode 1012, which extends from lead 1004 through aperture 1016. However, any suitable configuration of electrodes may be used. If the sample contains a target marker of interest, complex 1014 may form on the surface of working electrode 1012.

The detection system 1000 shown in FIG. 3 incorporates an illustrative three-electrode potentiostat configuration, however it should be understood that any suitable configuration of components may be used, and the terminals of the potentiostat may be coupled to the various electrodes in any suitable manner. Counter electrode 1008 is connected to the output terminal of control amplifier 1018. Working electrode 1014 through lead 1004 is connected to a transimpedance amplifier (TIA) 1020. The TIA presents a virtual ground to the working electrode. Detection module 1022 is connected to the output of the TIA The detection module 1022 may be configured to provide real-time current measurement in response to any input waveform. Reference electrode 1010 is connected to the inverting terminal of control amplifier 1018. Signal generator 1024 is connected to the non-inverting terminal of control amplifier 1018. This configuration maintains constant potential at the working electrode (relative to the solution) while allowing for accurate measurements of the current. Additional compensation networks and control loops may be used. These circuits would be well known to those skilled in the art and would be fitted to specific applications.

Control and communication unit 1026 is operably coupled to detection module 1022 and signal generator 1024. Control and communication unit 1026 may synchronize the input waveforms and output measurements, and may receive and store the input and output in a memory. In some implementations, control and communication unit 1026 is a separate unit that interfaces with a detection system. For example, detection system 1000 may be a disposable cartridge with a plurality of input and output terminals that can interface with control and communication unit 1026. In some implementations, control and communication unit 1026 is operably coupled to a display unit that displays the output as a function of input. In some implementations, control and communication unit 1026 transmits the input and output information to a remote destination for storage and display. For example, control and communication unit 1026 could be a mobile device or capable of being interfaced with a mobile device. In some implementations, control and communication unit 1026 provides power to the detection system 1000. Detection system 1000 may be powered using any suitable power source, including a battery or a plugged-in AC power source.

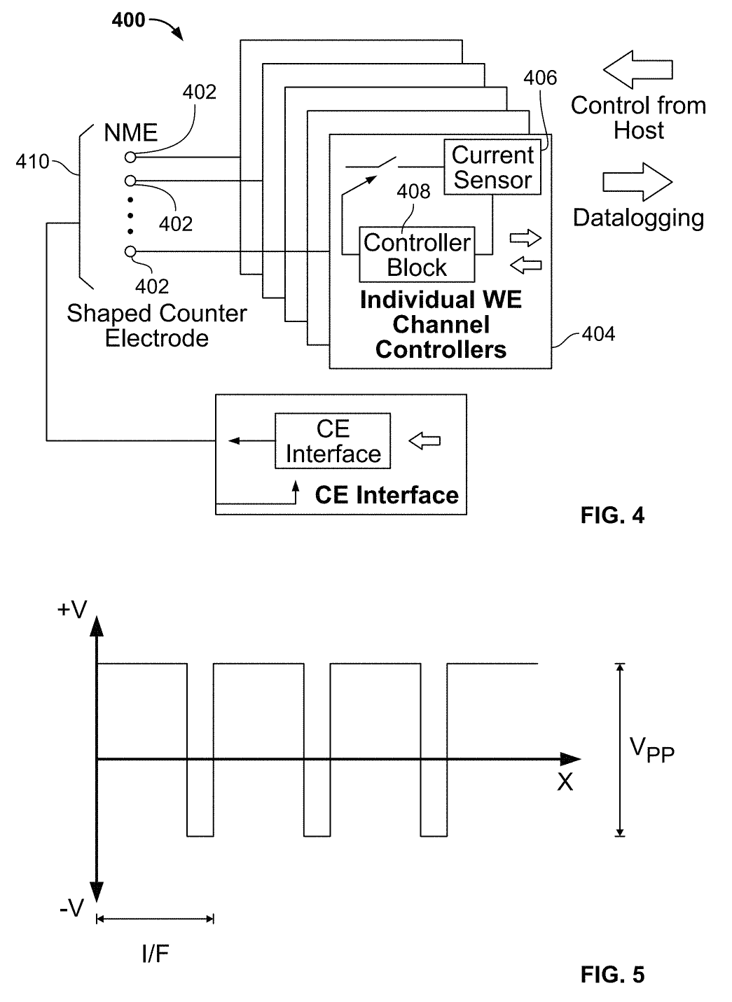

FIG. 4 shows an illustrative embodiment of a plate-stop controller 400 for growing nanostructured microelectrodes (NMEs) 402. Each working electrode 402 is affixed to a solid support or substrate, such as a silicon wafer, petri dish, or glass slide (not shown), coupled to a voltage source for growing an NME. The working electrodes 402 may be put in contact with an electrolyte (e.g. immersed in an electrolyte solution). In some implementations, a common potential can be applied to each of the working electrodes, for example, by a common potentiostat. In some implementations, each working electrode can have its own potentiostat. Each working electrode is operatively coupled to a channel controller 404, and each channel controller has a current sensor 406 (to determine a current that is passing through the working electrode) and a controller block 408 to block or interrupt the potential from the working electrode 402. The system may be operably coupled to a host device that controls and monitors the plating processing. A shaped counter electrode 410 is shared by all of the working electrodes 402 during the plating process, and is shaped in such a way that the effective resistance between each growing NME 402 and the counter electrode 410 appears substantially similar for each working electrode 402 to prevent uneven growth. The potential applied to the shaped counter electrode may be controlled by a separate interface allowing a separate current through each of the one or more working electrodes to be monitored.

In some implementations, a controller block 404 may determine that a current through its corresponding working electrode 402 has exceeded a predetermined value (or threshold) or has reached a predetermined range, which is indicative of the corresponding NME 402 achieving a particular surface area. In order to prevent the NME 402 from growing further, the controller block 408 may remove the applied potential from the working electrode 402. This process will continue until all of the currents measured through each NME 402 have exceeded the predetermined value or reached the predetermined range, ensuring that all NMEs 402 are of similar morphology and have substantially the same surface area.

In some implementations, the working electrodes are cleaned and seeded prior to growing the NMEs. Cleaning the electrodes and plating the seed layer avoids delay in NME growth due to irregularities and imperfections in the working electrodes. The plating process may start with several reverse potential cleaning pulses to strip material from the working electrode. In some embodiments, the pulses are 1-2 seconds long at 1 to 1.2 V. In some embodiments, for gold working electrodes, 2 seconds is sufficient for cleaning while substantially more than 5 seconds will cause removal of the working electrode pad.

FIG. 5 shows an illustrative waveform for optimizing the growth of a seed layer for a subsequently grown NME. In some implementations, the working electrode is driven with a 95% duty cycle, 1.4 Vₚₚ, 1 Hz square wave. This forms a very dense seed layer with little to no branching. As small branches form, they are removed by the reverse plating pulse, which is likely due to their larger surface area to volume ratio, as compared to the bulk growth of the NME. In some implementations, the pulse plating magnitude and positive offset is gradually increased over a period of several minutes. The time spent pulse plating has a large bearing on the final structure of the electrode. Excessive time spent pulse plating and/or excessive potential during this process results in a structure with a large dense core. Empirically, the optimal time to stop pulse plating is one which results in 0.375 to 0.5 μA per electrode at 900 mV applied potential, which can be used as a predetermined range to place a limit on the size of the seed layer.

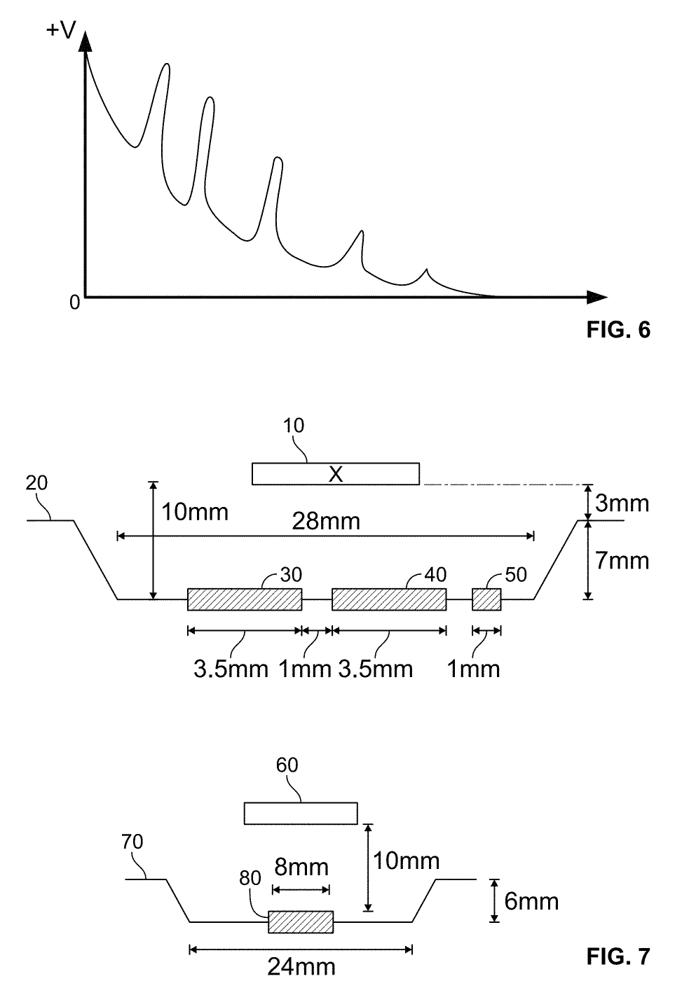

After the initial seed layer is grown, the plating process can be switched over to a bulk plating process which generates the branched NME. In some embodiments, a fixed DC potential, exponential taper, or an exponential taper with sharp pulses can be used. The fixed DC potential and simple exponential taper both yield a branched NME. The exponential taper shows some improvement over the fixed DC potential in plating speed without degrading the quality of the structure. FIG. 6 shows an illustrative exponential taper with sharp pulses. The plating profile with the exponential taper with added sharp pulses showed an improvement in fine structure over various other waveforms.

While the plate stop controller 400 ensures a constant potential to electrode current ratio, the effective electrode size can also be optimized to account for geometry effects. This can be achieved by engineering the shape and spacing of the counter electrode 410 with respect to each working electrode 402 on the chip such that the effective distance to each working electrode 402 is constant. This, in turn, maintains an effective solution resistance between the counter electrode 410 and a particular working electrode 402 such that the resistance remains substantially constant for all working electrodes. This design improves upon plating methods that utilize a counter electrode wire dipped near one end of the chip, which results in tapered electrode sizes with the largest grown electrode furthest from the counter electrode.

The effective resistance between any given working electrode 402 and the counter electrode 410 is the inverse of the integrated conductance from each working electrode 402 to every point on the counter electrode 410. When considering this distance, an optimal shape can be determined by taking the inverse of the integral of the inverse of the distance from a given working electrode to all points on the counter electrode. While this yields a smooth curve, in practice it is difficult to produce this shape using standard manufacturing techniques. As an alternative, a simpler form with fewer bends and an insulated center section was designed to both limit the amount of conductive material used (such as platinum) and allow the electrode to fit within a Petri dish. FIG. 7 shows illustrative embodiments of counter electrodes 20 and 70. Solid supports 10 and 60 are spaced apart from counter electrodes 20 and 70, respectively. The counter electrodes 20 and 70 may be shaped and may, for example with curved or linear sections. Counter electrode 20 has insulating regions 30, 40, and 50 that block current flow from working electrodes on solid support 10 to counter electrode 20. In some embodiments, insulating regions may be spaced the same distance away from a central portion of counter electrode, as illustrated by insulators 30 and 40. In some embodiments, the insulator may block current flow through a central portion of the counter electrode, as illustrated by insulator 80.

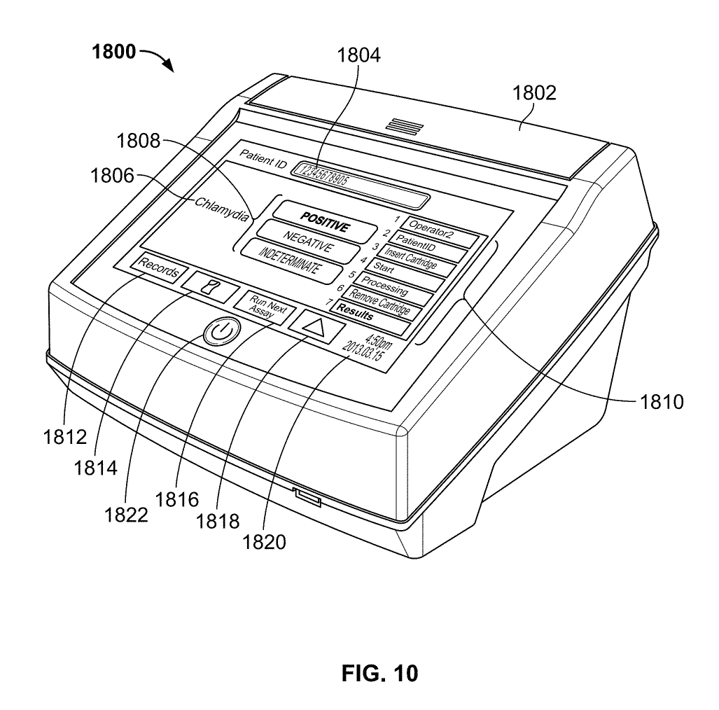

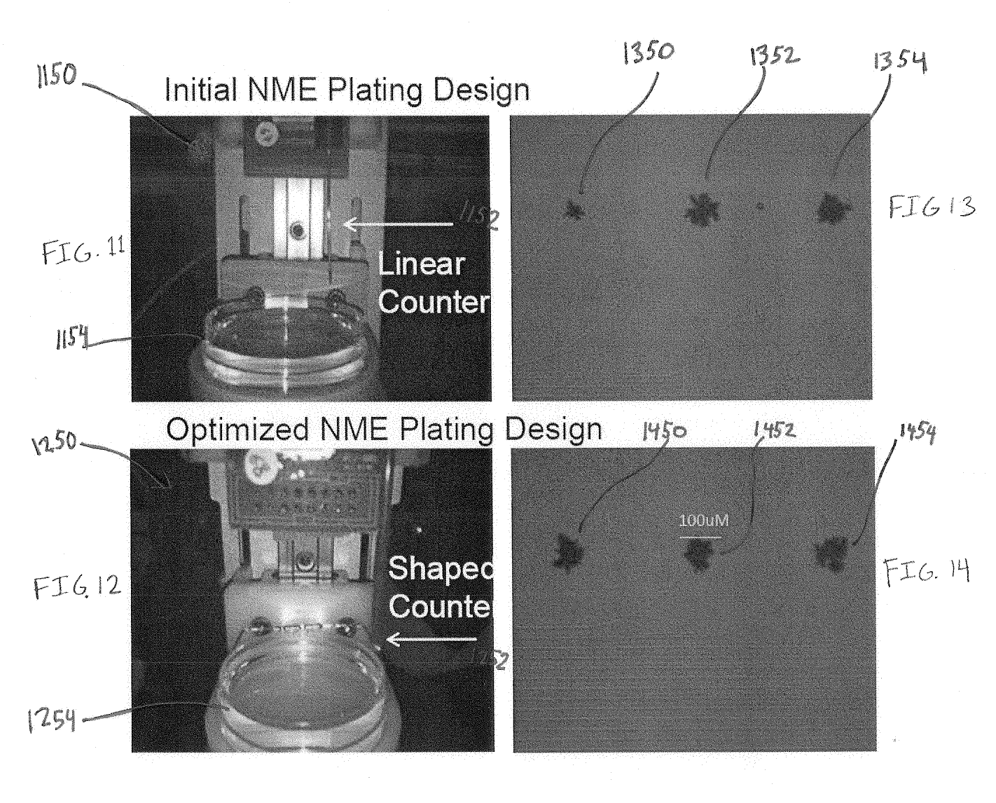

FIGS. 11-14 show NME plating designs and NMEs made using the plating designs. FIG. 11 shows an NME plating system 1150 having a linear counter electrode 1152 suspended over a Petri dish 1154. FIG. 13 shows NMEs 1350, 1352, and 1354 created using the plating system 1150. There is a significant disparity in the size of the NMEs produced using this system. For example, the NME 1350 is significantly smaller than NMEs 1352 and 1354. FIG. 12 shows a plating system 1250 having a shaped counter electrode 1252 suspended over a petri dish 1254. FIG. 14 shows NMEs 1450, 1452, 1454 created using the plating system 1250. In contrast to the NMEs produced using the linear counter electrode 1152, the NMEs 1450, 1452, and 1454 are of substantially uniform size. In FIG. 14, the NMEs 1450, 1452, and 1454 are all on the order of 100 microns in width.

In some implementations, the electrochemical detector is fabricated as a standalone chip with a plurality of pins. The pins may be arranged in any suitable fashion to interface with an external processor for which quantitative determinations, such as threshold comparisons, can be performed. The electrochemical detector includes a readout device that generates an indicator to communicate the results of the detection. The readout device may be any suitable display device, such as LED indicators, a touch-activated display, an audio output, or any combination of these. Any suitable mechanism for indicating the presence or absence of the target may be used. For example, the indicator may include an amplitude of the first response signal, a concentration of the first target marker determined based on the first response signal, a color-coded indicator selected based on the response signal, a symbol selected based on the a particular response signal, a graphical representation of the response signal over a plurality of values for a corresponding input signal, and any suitable combination thereof.

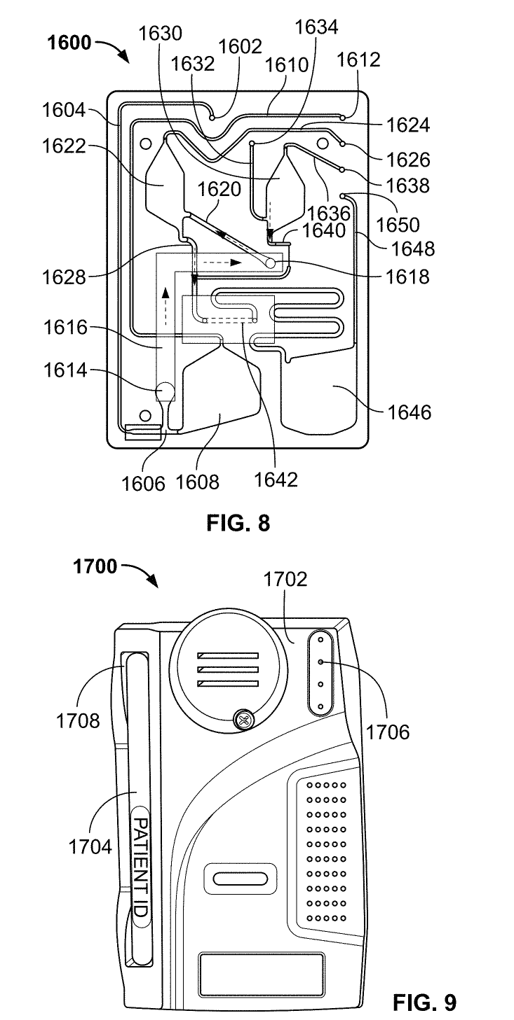

The systems, devices, methods, and all embodiments described above may be incorporated into a cartridge to prepare a sample for analysis and perform a detection analysis. FIG. 8 depicts a cartridge system 1600 for receiving, preparing, and analyzing a biological sample. For example, cartridge system 1600 may be configured to remove a portion of a biological sample from a sample collector or swab, transport the sample to a lysis zone where a lysis and fragmentation procedure are performed, and transport the sample to an analysis chamber for determining the presence of various markers and to determine a disease state of a biological host.

FIG. 9 depicts an embodiment of a cartridge for an analytical detection system. Cartridge 1700 includes an outer housing 1702, for retaining a processing and analysis system, such as system 1600. Cartridge 1700 allows the internal processing and analysis system to integrate with other instrumentation. Cartridge 1700 includes a receptacle 1708 for receiving a sample container 1704. A sample is received from a patient, for example, with a swab. The swab is then placed into container 1704. Container 1704 is then positioned within receptacle 1708. Receptacle 1708 retains the container and allows the sample to be processed in the analysis system. In certain approaches, receptacle 1708 couples container 1704 to port 1602 so that the sample can be directed from container 1704 and processed though system 1600. Cartridge 1700 may also include additional features, such as ports 1706, for ease of processing the sample. In certain approaches, ports 1706 correspond to ports of system 1600, such as ports 1602, 1612, 1626, 1634, 1638, and 1650 to open or close to ports or apply pressure for moving the sample through system 1600.

Cartridges may use any appropriate formats, materials, and size scales for sample preparation and sample analysis. In certain approaches, cartridges use microfluidic channels and chambers. In certain approaches, the cartridges use macrofluidic channels and chambers. Cartridges may be single layer devices or multilayer devices. Methods of fabrication include, but are not limited to, photolithography, machining, micromachining, molding, and embossing.

FIG. 14 depicts an automated testing system to provide ease of processing and analyzing a sample. System 1800 may include a cartridge receiver 1802 for receiving a cartridge, such as cartridge 1700. System 1800 may include other buttons, controls, and indicators. For example, indicator 1804 is a patient ID indicator, which may be typed in manually by a user, or read automatically from cartridge 1700 or cartridge container 1704. System 1800 may include a “Records” button 1812 to allow a user to access or record relevant patient record information, “Print” button 1814 to print results, “Run Next Assay” button 1818 to start processing an assay, “Selector” button 1818 to select process steps or otherwise control system 1800, and “Power” button 1822 to turn the system on or off. Other buttons and controls may also be provided to assist in using system 1800. System 1800 may include process indicators 1810 to provide instructions or to indicate progress of the sample analysis. System 1800 includes a test type indicator 1806 and results indicator 1808. For example, system 1800 is currently testing for Chlamydia as shown by indicator 1806, and the test has resulted in a positive result, as shown by indicator 1808. System 1800 may include other indicators as appropriate, such as time and date indicator 1820 to improve system functionality.

The foregoing is merely illustrative of the principles of the disclosure, and the systems, devices, and methods can be practiced by other than the described embodiments, which are presented for the purposes of illustration and not of limitation. It is to be understood that the systems, devices, and methods disclosed herein, while shown for use in detection systems for bacteria, and specifically, for Chlamydia Trachomatis, may be applied to systems, devices, and methods to be used in other applications including, but not limited to, detection of other bacteria, viruses, fungi, prions, plant matter, animal matter, protein, RNA sequences, DNA sequences, as well as cancer screening and genetic testing, including screening for genetic disorders.

Variations and modifications will occur to those of skill in the art after reviewing this disclosure. The disclosed features may be implemented, in any combination and subcombination (including multiple dependent combinations and subcombinations), with one or more other features described herein. The various features described or illustrated above, including any components thereof, may be combined or integrated in other systems. Moreover, certain features may be omitted or not implemented. All references cited are hereby incorporated by reference herein in their entireties and made part of this application.

1. A method for plating electrodes, the method comprising:
contacting a substrate with an electrolyte, the substrate comprising a plurality of working electrodes;
applying an electric potential to one or more working electrodes of the plurality of working electrodes;
monitoring a separate current through each of the one or more working electrodes of the plurality of working electrodes; and
in response to determining that a first current through a first electrode of the plurality of working electrodes has reached a predetermined value, interrupting the first current through the first working electrode.

2. The method of claim 1, wherein applying the potential to the first electrode produces a nanostructured microelectrode.

3. The method of claim 1, wherein interrupting the first current comprises removing the potential applied to the first working electrode while continuously applying the potential to the remaining working electrodes of the plurality of electrode leads.

4. The method of claim 1, wherein the plurality of working electrodes share a common counter electrode.

5. The method of claim 4, wherein the common counter electrode is shaped such that a resistance between each of the plurality of working electrodes and the common counter electrode is substantially similar among the plurality of working electrodes.

6. The method of claim 1, wherein the potential applied to each of the plurality of working electrodes is controlled by a common potentiostat.

7. The method of claim 1, wherein the currents measured through each of the plurality of working electrodes is indicative of a surface area of their respective working electrodes.

8. The method of claim 1, further comprising:
determining that a second current through a second electrode of the plurality of electrode leads has reached a predetermined value; and
in response to determining that the second current has reached the predetermined value, removing the potential applied to the second electrode lead, wherein the surface area of the first electrode is substantially similar to the surface area of the second electrode after the potential applied to the second electrode is removed.

9. A method for controlling an electrode morphology, the method comprising:
applying a first waveform of alternating polarity to a working electrode,
determining that a current through the working electrode has reached a predetermined value,
in response to determining that the current is within a predetermined range, removing the first waveform from the working electrode; and
applying a second waveform of a non-alternating polarity to the working electrode.

10. The method of claim 9, wherein the predetermined range is indicative of a size of the working electrode.

11. The method of claim 9, wherein a first polarity of the waveform has a longer duration than a duration of a second polarity.

12. The method of claim 9, wherein the second waveform comprises an exponential decay having a plurality of peaks distributed along the exponential decay.

13. A system for plating electrodes, the system comprising control circuitry configured to perform the method according to claim 1.

14. A system for plating electrodes, the system comprising:
a solid support;
a plurality of working electrodes distributed on the surface of the solid support;
a counter electrode, wherein the counter electrode comprises:
a conductive region spaced a distance away from the plurality of working electrodes;
an insulator covering a portion of the conductive region such that current flow from a particular working electrode to the portion of the counter electrode is effectively blocked.

15. The system of claim 14, wherein the counter electrode includes one or more curved sections.

16. The system of claim 14, wherein the counter electrode includes one or more linear sections.

17. The system of claim 14, wherein an effective resistivity between a first working electrode of the plurality of electrodes and the counter electrode is substantially similar to an effective resistivity between a second working electrode of the plurality of electrodes and the counter electrode.

18. The system of claim 14, wherein the counter electrode is configured to fit within a Petri dish.

19. The system of claim 14, wherein each of the plurality of working electrodes are operably coupled to a common potential.

20. The system of claim 14, wherein the insulator covers a portion or portions of the counter electrode.

21. The system of claim 14, wherein the counter electrode further comprises:
a planar portion that is substantially parallel to the solid support; and
an angled portion that extends at an angle from the planar portion.

22. The system of claim 14, wherein the counter electrode is formed into the shape of an electrolyte confinement well.

23. A point-of-care diagnostic device comprising a biosensor having electrodes produced according to the method of claim 1.
